(19) United States
(12) Patent Application Publication
(10) Pub. No.: US 2005/0215929 A1
(43) Pub. Date: Sep. 29, 2005

(54) Massage hand tool

(76) Inventor: Brian Dill, Port Orchard, WA (US)

Correspondence Address: National IP Rights Center, LLC, Suite 400, 550 Township Line Road, Blue Bell, PA, 19422, US

(21) Appl. No.: 10/807,038

(22) Filed: Mar. 23, 2004

(51) Int. Cl. A61H 7/00; A61H 15/00

(52) U.S. Cl. 601/135; 601/137

(57) ABSTRACT

A massage hand tool is disclosed. The massage hand tool includes a first engagement portion, a first support shaft, having a first end and a second end, wherein the second end of the first support shaft is attached to the first engagement portion and the support shaft proceed substantially perpendicularly outward therefrom, and a first handle, having a first end and a second end, wherein the second end of the first handle is mounted at the first end of the first shaft and proceeds substantially perpendicularly outward therefrom.

### FIELD OF THE INVENTION

The present invention relates to devices used in massage, and in particular to a massage hand tool.

### BACKGROUND OF THE INVENTION

It is well known that massage is a useful way of relaxing the body as well as helping to condition the muscles in the body. Anyone who has received a massage can attest to the fact that it has been beneficial to them. However, it is not an easy task to perform a massage by the masseuse, whether a professional or an amateur. One issue, in particular, is that giving a massage can be a straining workout on the hands of the masseuse as he or she tries to achieve the pressures on the receiver's muscles to actually accomplish an effective massage. Accordingly, it would be useful to have tools to aid in the massage that would spare the masseuse's hands and tendons, while providing a worthwhile massage. Additionally, the tools would be most beneficial if they could be used by hand and were of a variety of sizes and shapes so that various different areas of the body could be easily and effectively massaged.

U.S. Pat. No. 5,231,977 is directed to a set of tools for use by a trainer in performing soft tissue massage, wherein each tool includes a handle portion and a skin engagement portion that is configured to generally match the contour of the impaired area of soft tissue to be treated. The skin engagement portion includes an edge surface that noninvasively engages the skin to allow the user to locate fibrous adhesions that are attached to the underlying soft tissue areas. A first tool is selected having a beveled edge for breaking up the scar tissue, whereafter a second tool may then be selected having a blade edge for pulling the broken up scar tissue away from the affected soft tissue area. The soft tissue area is then stretched as much as possible and the treatment repeated until all of the scar tissue has been removed from the soft tissue area.

U.S. Pat. No. 5,817,037 discloses a method and apparatus for the treatment of myofascial pain, RSI and mechanical injury to soft tissue. The apparatus includes a treatment tool having a construction and design so as to enable high-pressure deep tissue massage sufficient to reduce both edema and nerve sensitivity. The treatment tool is constructed and arranged to provide a predetermined contoured treatment surface. Method steps are provided utilizing the treatment tool for soft tissue injury.

U.S. Pat. No. 5,843,005 is directed to a hand held device for deep tissue massage and/or for augmenting lymphatic drainage which also utilizes negative ionic therapy, having a tool part with a head end of a preselected shape that is removably attached to a handle part. The handle part has an ergonomic, substantially oval shape of a predetermined diameter and thickness. The device further has a negative ion emitting surface covering at least a portion of the tool part or the handle part. A method of deep tissue massage and negative ionic therapy is also provided.

U.S. Pat. No. 6,010,469 discloses a massage tool with which a professional massager can apply the full force generated by their arm to a precise body area, without any finger or wrist stress, even over indefinitely prolonged periods. The massage tool comprises: an elongate handle member adapted to lay across the palm of a hand and be encircled by the fingers; a first leg member extending outwardly from one end portion of the elongate handle member; a first foot member extending from the outward end portion of the first leg member in a direction lateral to, and away from the palm of the hand. The foot member has a length exceeding the thickness of the thumb and has a heel portion, side portions, and an outside end portion all of which are adapted for rubbing. The leg member is generally the length of the thumb so that the inner side of the thumb may lay along the front side portion of the leg member and the end of the thumb may press against the top side portion of the foot member. In a preferred embodiment the massage tool includes a second leg member and foot member so that one can rub with either the foot in the heel of one's hand or with the foot positioned adjacent to one's thumb. Most preferably the tool is made of ceramic.

U.S. Patent Publication No. 2003/0114781 is directed to a hand-held massage tool for promoting circulation to the tissue and muscles of a patient. The hand-held massage tool comprises a substantially conical first end and a dome-like second end substantially opposite the first end. A concave elongated center portion is positioned between the first end and the second end with the center portion having a longitudinal axis and being shaped for grasping by a single hand for beneficial manipulation of the first end and the second end against a patient using slight adjustments while maintaining contact with the patient. A method for massaging a patient is also provided.

U.S. Pat. No. 5,766,210 is directed to providing devices and methods for therapeutically treating a variety of body parts. An exemplary massage device comprises an elongate shaft having a proximal end and a distal end. A head is attached to the distal end of the shaft and includes a plurality of surface for interaction with a body part. At least two of the surfaces on the head each include a plurality of resilient knobs which are distributed over their surfaces. The knobs on one of the two surfaces are different from the knobs on the other surface. A handle is removably attached to the proximal end of the shaft.

U.S. Pat. No. 6,126,620 is directed to a method and a system for use by a trainer in performing soft tissue massage. The system includes a tool including a handle portion and a skin engagement portion that is configured to generally match the contour of the impaired area of soft tissue to be treated. The tool is connected to a source of electrical current far providing electrical stimulation to the impaired area during treatment with the tool. The skin engagement portion noninvasively engages the skin to allow the user to locate fibrous adhesions that are attached to the underlying soft tissue areas.

U.S. Pat. No. 4,210,135 is directed to a plurality of non-rotating disc-shaped massaging members are fixed on a flexible shaft held at its ends by a bow. Spherical rolling members between the massaging members space the massaging members apart and limit their depth of depression into the skin.

U.S. Pat. No. 5,441,478 is directed to a set of tools for use by a trainer in performing soft tissue massage, wherein each tool includes a handle portion and a skin engagement portion that is configured to generally match the contour of the impaired area of soft tissue to be treated. The skin engagement portion includes an edge surface that noninvasively engages the skin to allow the user to locate fibrous adhesions that are attached to the underlying soft tissue areas. A first tool is selected having a beveled edge for breaking up the scar tissue, whereafter a second tool may then be selected having a blade edge for pulling the broken up scar tissue away from the affected soft tissue area. The soft tissue area is then stretched as much as possible and the treatment repeated until all of the scar tissue has been removed from the soft tissue area.

U.S. Pat. No. 6,267,738 discloses a treatment tool and method of using the same are provided for treating soft tissue by the application of pressure to muscles used in various therapeutic techniques such as trigger point, friction, effleurage and muscle stripping. In one embodiment, the present invention comprises a massage tool having a shaft of a predetermined length and one or more ring members associated with the shaft member for providing muscle stripping and other therapy. The massage tool is of a weight sufficient to assist the therapist in delivering therapy. In another embodiment, the present invention comprises a paddle formed in one end of the shaft. In another embodiment, the massage tool of the present invention has a point member formed in a second end of the shaft for providing trigger point and other therapy.

None of the above references provide, however, a massage hand tool that allows a masseuse to perform a variety of massages effectively. There is therefore a need for a massage hand tool that allows a masseuse to provide a massage effectively while sparing the hands and arms of the masseuse from the stresses required to perform a massage.

### OBJECTS AND SUMMARY OF THE INVENTION

It is an object of the present invention to provide a massage hand tool which will allow a masseuse to perform a massage while sparing the masseuse some of the stresses of performing the massage.

It is a further object of the present invention to provide a massage hand tool that can be used for a variety of massages.

It is a further object of the present invention to provide a massage hand tool that includes an engagement portion, and a handle attached to the engagement portion for the masseuse to hold the massage hand tool.

It is yet a further object of the present invention to provide a massage hand tool that includes a handle, a support shaft and an engagement portion.

It is yet a further object of the present invention to provide a massage hand tool that includes a two handles, two support shafts, two engagement portions, and a transverse shaft.

In accordance with a first aspect of the present invention, a novel massage hand tool is provided. The novel massage hand tool includes an engagement portion for engaging a person, the engagement portion having a first side and a second side, and a first handle, mounted on the second side of the engagement portion.

In accordance with a further aspect of the present invention, a novel massage hand tool is provided having a support shaft. The novel massage hand tool includes an engagement portion, having a concave engagement face and a mounting end, a support shaft, having a first end and a second end, the second end of the support shaft mounted at the mounting end of the engagement portion, and a handle, mounted at the first end of the support shaft.

In accordance with yet a further aspect of the present invention, a novel massage hand tool is provided having two engagement portions. The novel massage hand tool includes a first substantially spherical engagement portion, a first support shaft, having a first end and a second end, wherein the second end of the first support shaft is attached to the first substantially spherical engagement portion and the support shaft proceed substantially perpendicularly outward therefrom, and a first handle, having a first end and a second end, wherein the second end of the first handle is mounted at the first end of the first shaft and proceeds substantially perpendicularly outward therefrom. The novel massage hand tool further includes a second substantially spherical engagement portion, a second support shaft, having a first end and a second end, wherein the second end of the second support shaft is attached to the second substantially spherical engagement portion and the second support shaft proceeds substantially perpendicularly outward therefrom, a second handle, having a first end and a second end, wherein the second end of the second handle is mounted at the first end of the second shaft and proceeds substantially perpendicularly outward therefrom, and a transverse shaft, having a first end and a second end, wherein the second end is mounted on the first substantially spherical engagement portion and proceeding generally perpendicularly therefrom, and the first end of the transverse shaft is mounted on the second substantially spherical engagement portion and proceeding generally perpendicularly therefrom.

### BRIEF DESCRIPTION OF THE DRAWINGS

The foregoing summary, as well as the following detailed description of a preferred embodiment of the present invention will be better understood when read with reference to the appended drawings, wherein:

FIG. 1A is a bottom perspective view of a massage hand tool in accordance with the present invention.

FIG. 1B is a top perspective view of the massage hand tool as depicted in FIG. 1A.

FIG. 2 is a perspective view of an alternative embodiment of a massage hand tool in accordance with the present invention.

FIG. 3 is a side perspective view of an alternative embodiment of a massage hand tool having a spherical engagement portion in accordance with the present invention.

FIG. 4A is a side perspective view of an alternative embodiment of a massage hand tool having two spherical engagement portions in accordance with the present invention.

FIG. 4B is a front perspective view of the massage hand tool depicted in FIG. 4A.

FIG. 5 is a perspective view of an alternative embodiment of a massage hand tool having a convex curved engagement portion in accordance with the present invention.

FIG. 6 is a perspective view of an alternative embodiment of a massage hand tool having a plurality of convex curved engagement portions in accordance with the present invention.

FIG. 7 is a perspective view of an alternative embodiment of a massage hand tool having a transverse convex curved engagement portion in accordance with the present invention.

FIG. 8 is a side perspective view of an alternative embodiment of a massage hand tool adapted for mounting on an arm in accordance with the present invention.

FIG. 9 is a perspective view of an alternative embodiment of a massage hand tool having a large concave engagement portion in accordance with the present invention.

FIG. 10 is a perspective view of an alternative embodiment of a massage hand tool having a small concave engagement portion in accordance with the present invention.

### DETAILED DESCRIPTION OF THE PREFERRED EMBODIMENTS

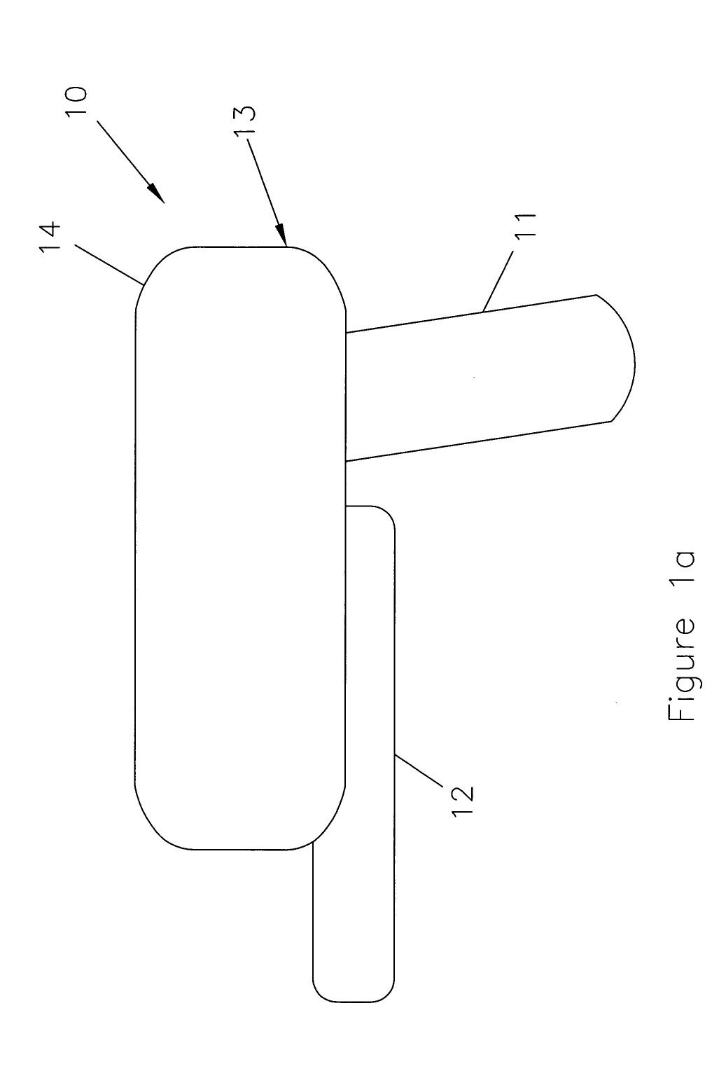

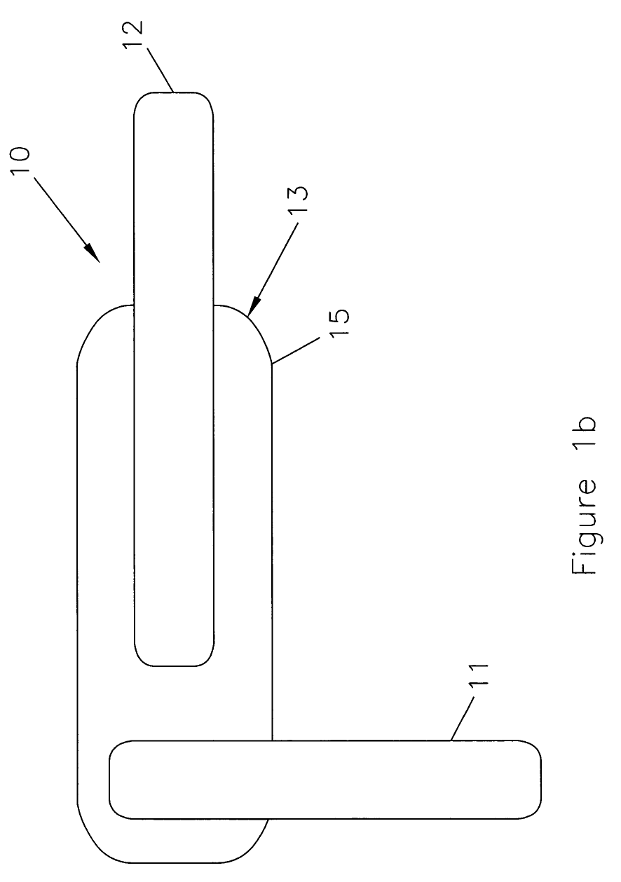

Referring now to the drawings, wherein like reference numerals refer to the same components across the several views and in particular to FIGS. 1A and 1B, there is shown a massage hand tool 10. The massage hand tool 10 includes a first handle 11, a second handle 12, and an engagement portion 13.

The engagement portion 13 has a curved first side 14 for engaging the body during a massage and a substantially flat second side 15. The first handle 11 is mounted on the second side 15 of the engagement portion 13 proximate to an end of the engagement portion 13, and generally perpendicular to the orientation of the engagement portion 13. The second handle 12 is mounted on the second side 15 of the engagement portion 13 proximate to the mounting location of the first handle 11. The second handle 12 is oriented substantially perpendicular to the first handle 11.

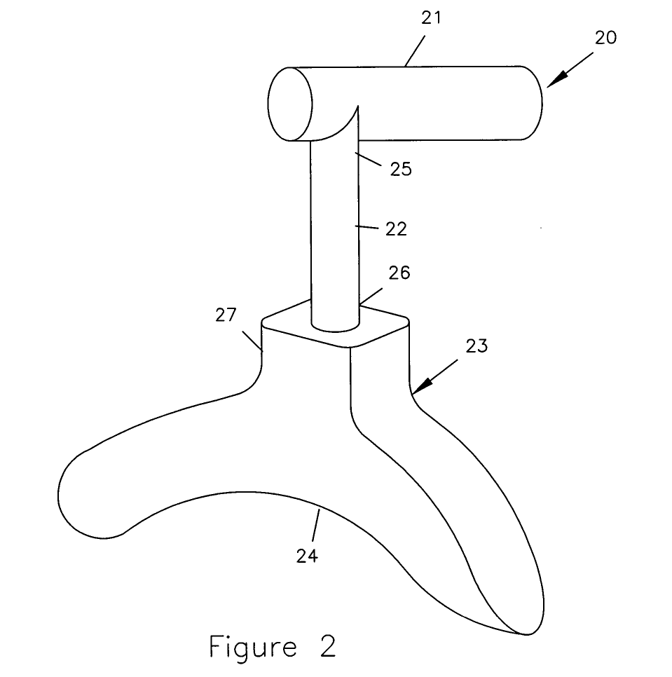

Referring now to FIG. 2, an alternative embodiment of a massage hand tool 20 is shown. The massage hand tool 20 includes a handle 21, a support shaft 22 and an engagement portion 23. The support shaft has a first end 25 and a second end 26. The engagement portion 23 has a concave engagement face 24 and a mounting end 27. The first end 25 of the support shaft 22 is attached to the handle 21 and the second end 26 of the support shaft 22 is attached to the mounting end 27 of the engagement portion 23. The concave engagement face 24 of the engagement portion 23 engages the body of a person to be massaged and the concave contour of the concave engagement face 24 to facilitate massaging certain areas of the body.

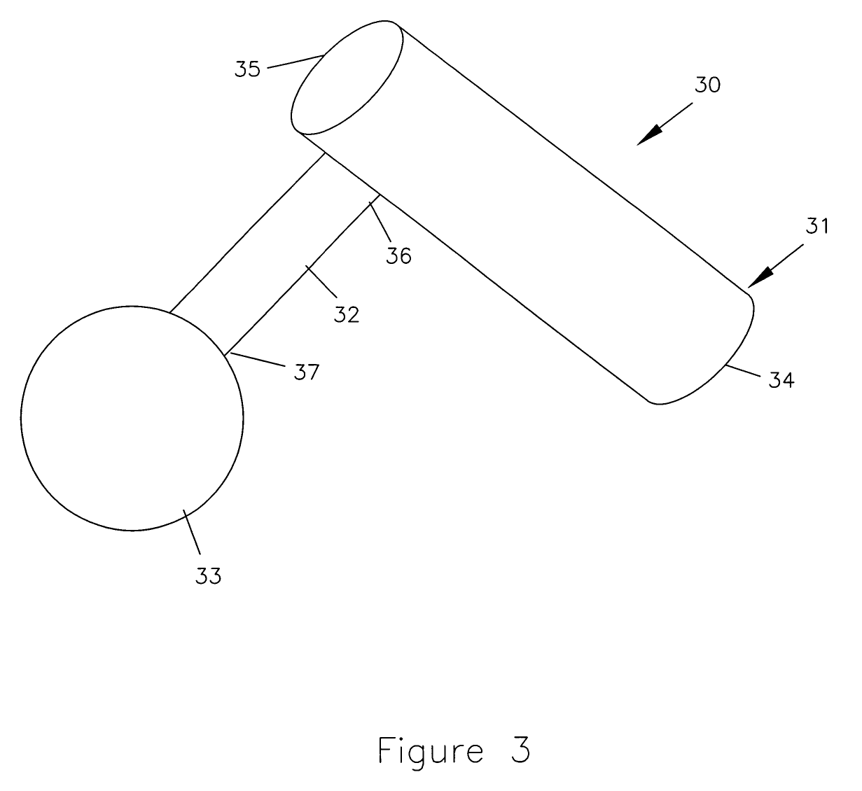

Referring now to FIG. 3, another alternative embodiment of a massage hand tool 30 is illustrated. The massage hand tool 30 includes a handle 31, a support shaft 32 and a substantially spherical engagement portion 33. The handle 31 has a first end 34 and a second end 35. The support shaft 32 has a first end 36 and a second end 37. The first end 36 of the support shaft 32 is attached to the second end 35 of the handle 31 and proceeds outwardly generally perpendicularly therefrom. The second end 37 of the support shaft 32 is attached to the substantially spherical engagement portion 33 and proceeds outwardly generally perpendicularly therefrom.

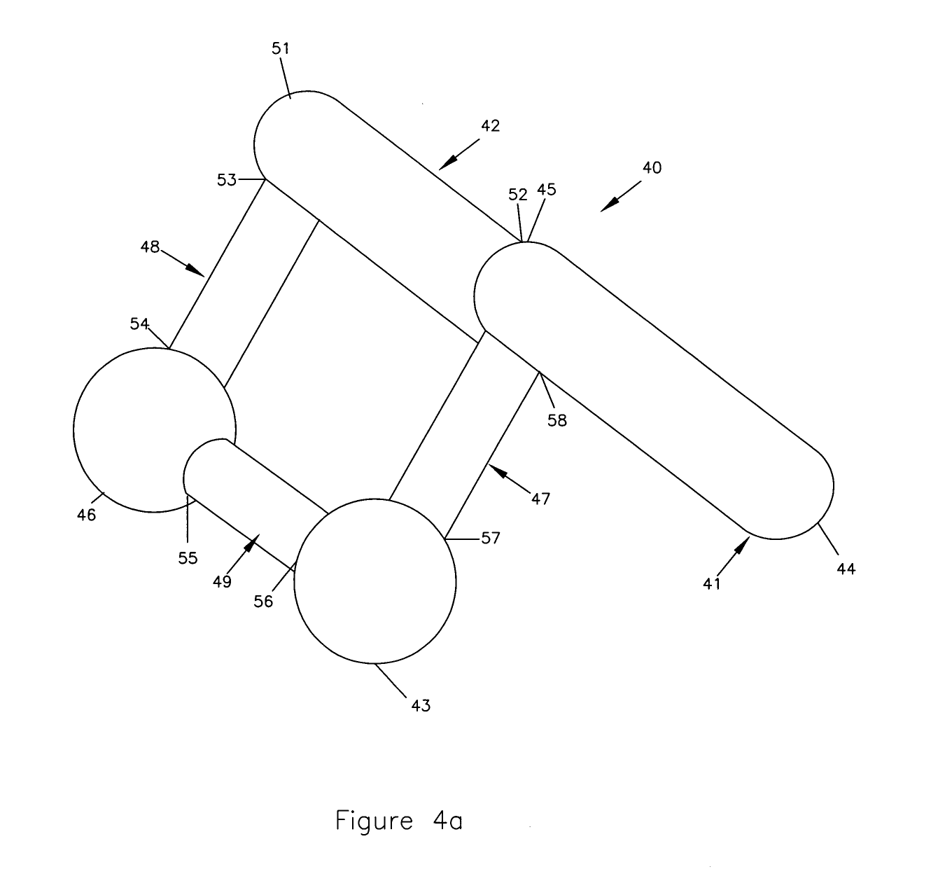

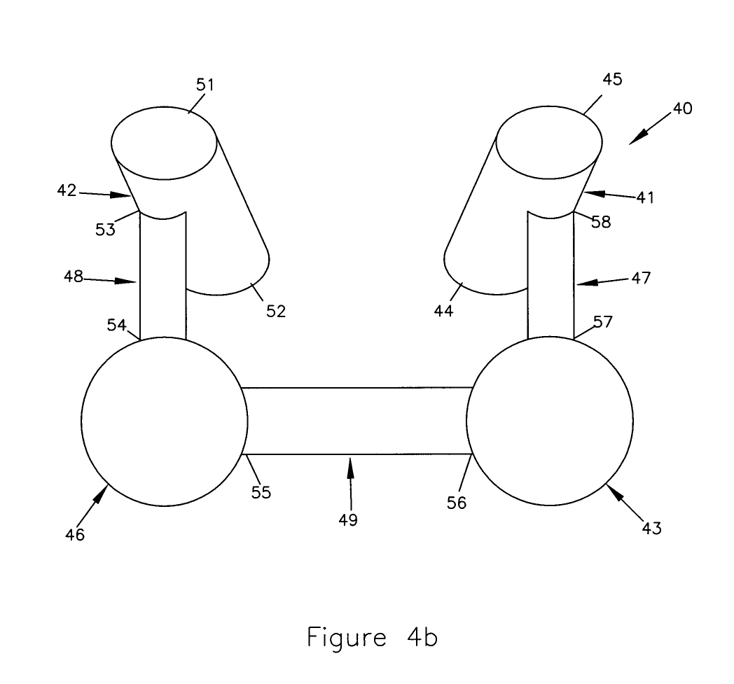

Another alternative embodiment of a massage hand tool 40 is depicted in FIGS. 4A and 4B. The massage hand tool 40 includes a first handle 41, a second handle 42, a first support shaft 47, a second support shaft 48, a first substantially spherical engagement portion 43, a second substantially spherical engagement portion 46, and a traverse shaft 49.

The first handle 41 has a first end 44 and a second end 45. The first support shaft 47 has a first end 58 and a second end 57. The first end 58 of the first support shaft 47 is attached to the second end 45 of the first handle 41 and proceeds outwardly generally perpendicularly therefrom. The second end 57 of the first support shaft 47 is attached to the first substantially spherical engagement portion 43 and proceeds outwardly generally perpendicularly therefrom. The second handle 42 has a first end 52 and a second end 51. The second support shaft 48 has a first end 53 and a second end 54. The first end 53 of the second support shaft 48 is attached to the second end 51 of the second handle 42 and proceeds outwardly generally perpendicularly therefrom. The second end 54 of the second support shaft 48 is attached to the second substantially spherical engagement portion 46 and proceeds outwardly generally perpendicularly therefrom. The transverse shaft 49 includes a first end 56 and a second end 55. The second end 55 of the transverse shaft 49 is attached to the second substantially spherical engagement portion 46 and proceeds outwardly generally perpendicularly therefrom, while the first end 56 of the transverse shaft 49 is attached to the first substantially spherical engagement portion 43 and proceeds outwardly generally perpendicularly therefrom. In a preferred embodiment of the present invention, the transverse shaft 49 is generally perpendicular in orientation to the first support shaft 47 and the second support shaft 48. However, any orientation known to one of ordinary skill in the art may be employed.

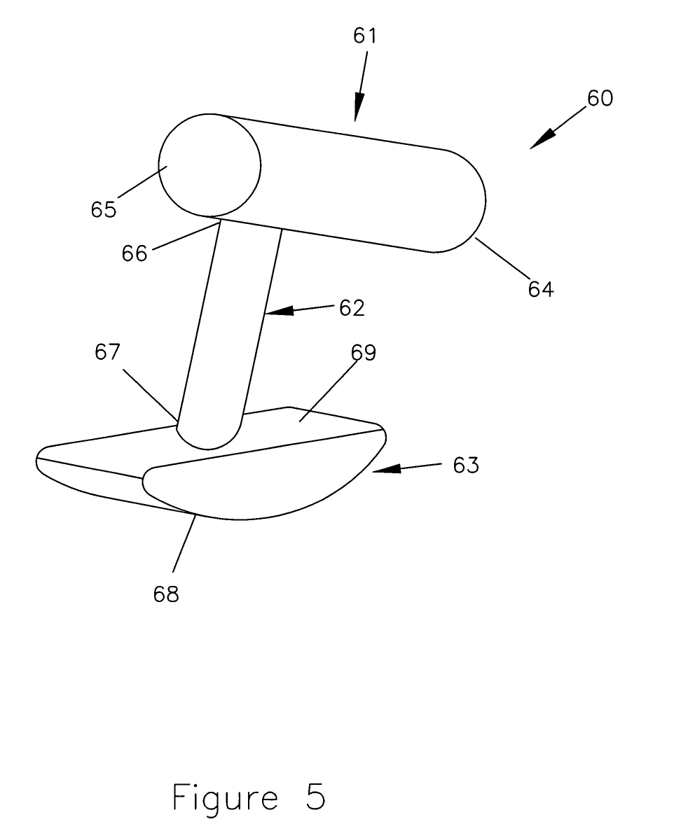

Referring now to FIG. 5, another alternative embodiment of a massage hand tool 60 is illustrated. The massage hand tool 60 includes a handle 61, a support shaft 62, and an engagement portion 63. The handle 61 has a first end 64 and a second end 65. The support shaft 62 has a first end 66 and a second end 67. The engagement portion 63 includes a convex engagement face 68 and a substantially flat mounting end 69. The first end of the support shaft 62 is attached to the second end 65 of the handle 61 and the second end 67 of the support shaft 62 is attached generally centrally to the substantially flat mounting end 69 of the engagement portion 63 and proceeds generally perpendicularly outwardly therefrom.

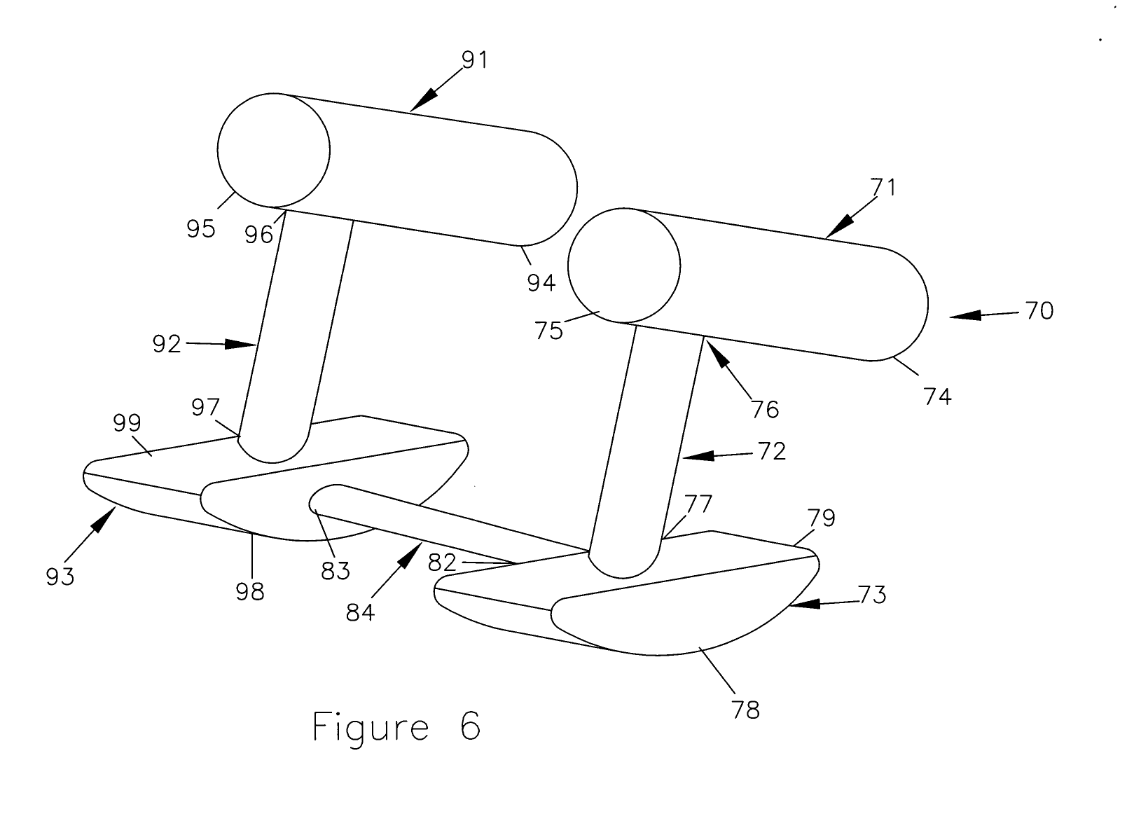

Referring now to FIG. 6, another alternative embodiment of a massage hand tool 70 is shown. The massage hand tool 70 includes a first handle 71, a second handle 91, a first support shaft 72, a second support shaft 92, a first engagement portion 73, a second engagement portion 96, and a traverse shaft 81. The first engagement portion has a convex engagement face 78 and a substantially flat mounting end 79. The second engagement portion 93 has a convex engagement face 98 and a substantially flat mounting end 99.

The first handle 71 has a first end 74 and a second end 75. The first support shaft 72 has a first end 76 and a second end 77. The first end 76 of the first support shaft 72 is attached to the second end 75 of the first handle 71 and proceeds outwardly generally perpendicularly therefrom. The second end 77 of the first support shaft 72 is attached generally centrally to the substantially flat mounting end 79 of the first engagement portion 73 and proceeds generally perpendicularly outwardly therefrom.

The second handle 91 has a first end 94 and a second end 95. The second support shaft 92 has a first end 96 and a second end 97. The first end 96 of the second support shaft 92 is attached to the second end 95 of the second handle 91 and proceeds outwardly generally perpendicularly therefrom. The second end 97 of the second support shaft 92 is attached generally centrally to the substantially flat mounting end 99 of the second engagement portion 93 and proceeds generally perpendicularly outwardly therefrom.

The transverse shaft 81 includes a first end 82 and a second end 83. The first end 82 of the transverse shaft 81 is attached to the first engagement portion 73 and proceeds outwardly generally perpendicularly therefrom, while the second end 83 of the transverse shaft 81 is attached to the second engagement portion 98 and proceeds outwardly generally perpendicularly therefrom. In a preferred embodiment of the present invention, the transverse shaft 81 is generally perpendicular in orientation to the first support shaft 72 and the second support shaft 73. However, any orientation known to one of ordinary skill in the art may be employed.

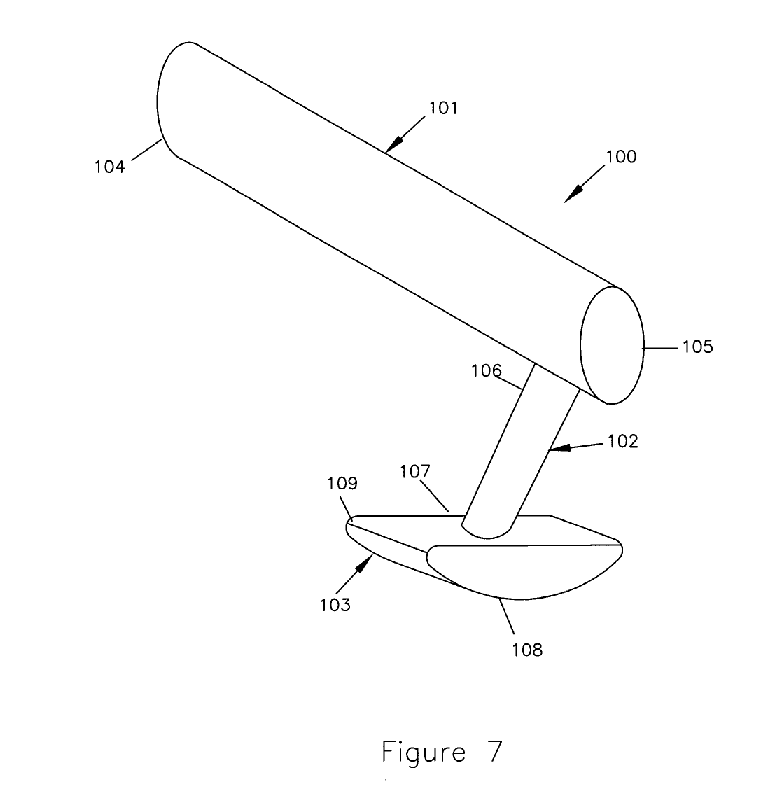

Referring now to FIG. 7, another alternative embodiment of a massage hand tool 100 is shown. The massage hand tool 100 includes a handle 101, a support shaft 102, and an engagement portion 103. The handle 101 has a first end 104 and a second end 105, and the support shaft has a first end 106 and a second end 107. The engagement portion 103 has a convex engagement face 108 and a mounting end 107. The first end 106 of the support shaft 102 is attached to the handle 101 at the second end 105 of the handle 101, and the second end 107 of the support shaft 102 is attached to the mounting end 109 of the engagement portion 103. The convex engagement face 108 of the engagement portion 103 engages the body of a person to be massaged and the concave contour of the convex engagement face 108 to facilitate massaging certain areas of the body.

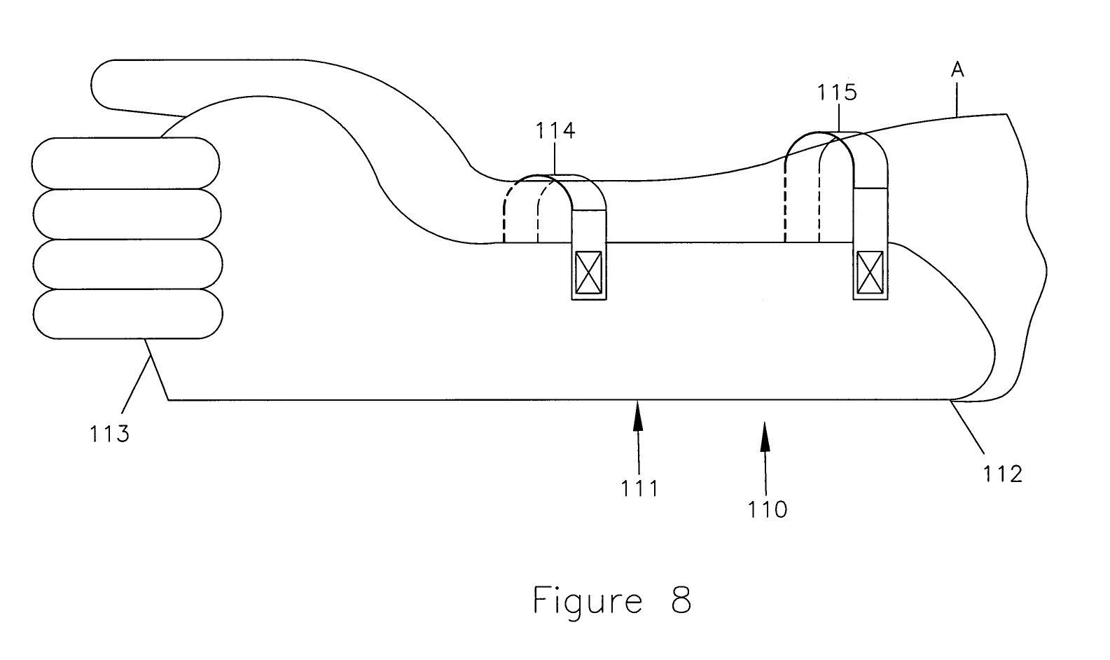

Another alternative embodiment of the present invention is depicted in FIG. 8 as massage hand tool 110. The massage hand tool 110 is generally contoured such that a human forearm ‘A’ can be easily placed within the massage hand tool 110 to facilitate its use. The massage hand tool 110 includes an engagement portion 111, a first end 112, a second end 113, a first strap 114, and a second strap 115. The first end 112 of the massage hand tool 110 is located generally where the elbow of a masseuse would rest, and the second end 113 of the massage hand tool 110 is located generally where the palm of the masseuse's hand would be situated. The first strap 114 is located generally one-third of the distance between the second end 113 and the first end 112 of the massage hand tool 110, and generally closer to the second end 113 than the first end 112. The second strap 115 is located generally one-third of the distance between the first end 112 and the second end 113 of the massage hand tool 110, and generally close to the first end 112 than the second end 113. The straps 114 and 115 are secured around the periphery of the forearm ‘A’ in order to secure the massage hand tool 110 to the forearm ‘A’. In this way, the masseuse may readily cause the engagement portion 111 to massage a patient with his forearm ‘A’. In a preferred embodiment of the present invention, the straps 114 and 115 are described as being located at distances of thirds between the first end 112 and the second end 113 of the massage hand tool 110, however any spacing of the straps 114 and 115 known to one of ordinary skill in the art is appropriate.

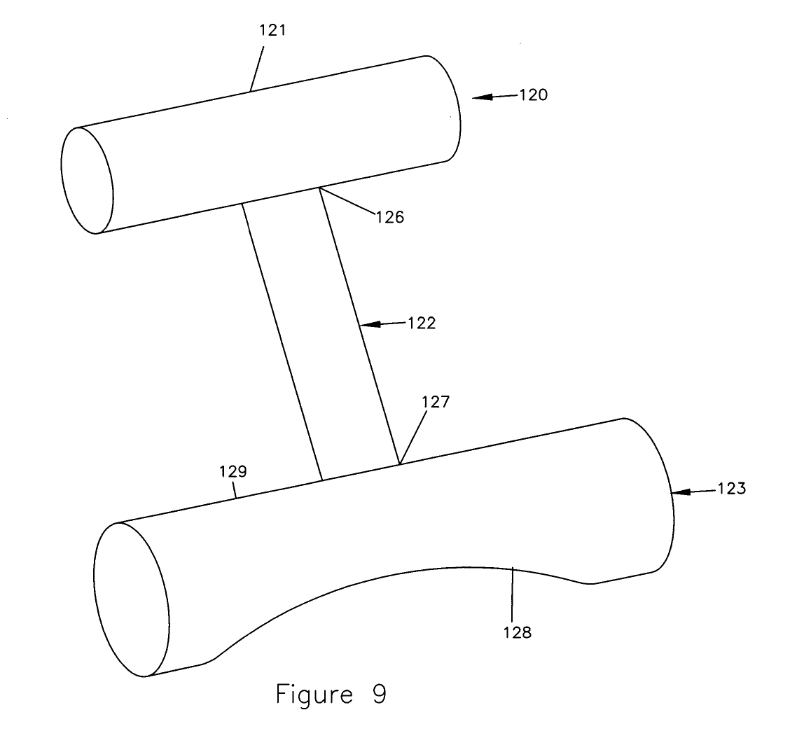

Referring now to FIG. 9, another alternative embodiment of a massage hand tool 120 is depicted. The massage hand tool 120 has a handle 121 a support shaft 122 and an engagement portion 123. The support shaft has a first end 126 and a second end 127. The engagement portion 123 has a concave engagement face 128 and a mounting end 129. The first end 126 of the support shaft 122 is attached to the handle 121 generally centrally and the second end 127 of the support shaft 122 is attached generally centrally to the mounting end 129 of the engagement portion 123. The concave engagement face 128 of the engagement portion 123 engages the body of a person to be massaged and the concave contour of the concave engagement face 128 to facilitate massaging certain areas of the body. In this configuration, the handle 121 is roughly the same length, or shorter than the length of the engagement portion 123.

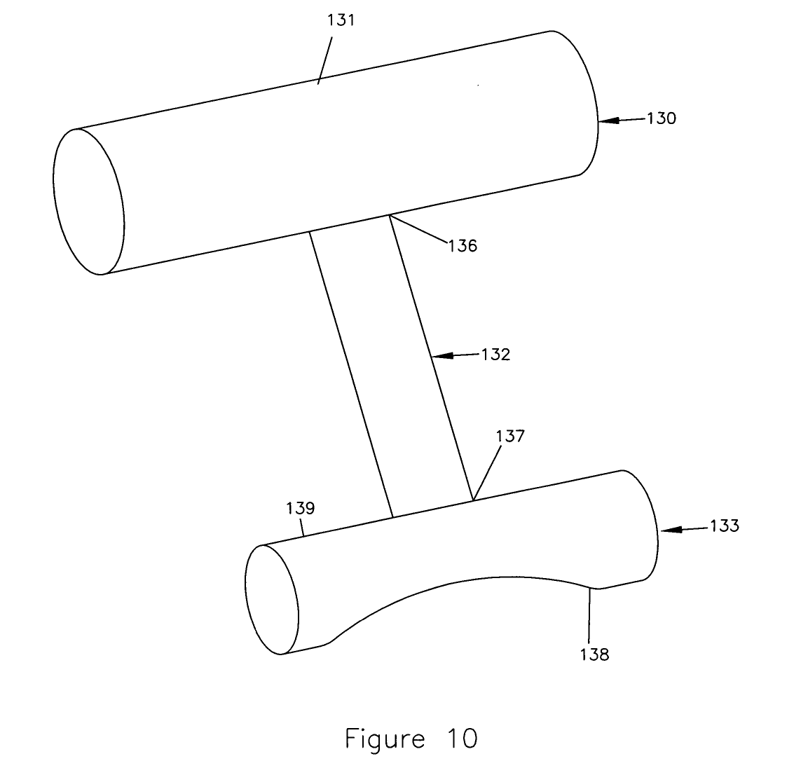

FIG. 10 illustrates yet another embodiment of the present invention in massage hand tool 130. The massage hand tool 130 has a handle 131 a support shaft 132 and an engagement portion 133. The support shaft has a first end 136 and a second end 137. The engagement portion 133 has a concave engagement face 138 and a mounting end 139. The first end 136 of the support shaft 132 is attached to the handle 131 generally centrally and the second end 137 of the support shaft 132 is attached generally centrally to the mounting end 139 of the engagement portion 133. The concave engagement face 138 of the engagement portion 133 engages the body of a person to be massaged and the concave contour of the concave engagement face 138 to facilitate massaging certain areas of the body. In this configuration, the handle 131 is somewhat longer than the length of the engagement portion 133.

In view of the foregoing disclosure, some advantages of the present invention can be seen. For example, a novel massage hand tool is disclosed. The novel massage hand tool allows for a masseuse to provide a much more effective massage to a patient since the masseuse's hands and arms will be spared some of the stresses of performing the massage. In this way, the masseuse can perform the massage for a longer period of time and more effectively. Additionally, a variety of configurations of the massage hand tool are disclosed, such as massage hand tools having spherical, concave and convex engagement portions or faces. This allows the masseuse to provide a variety of massages.

While the preferred embodiments of the present invention have been described and illustrated, modifications may be made by one of ordinary skill in the art without departing from the scope and spirit of the invention as defined in the appended claims. For example, in a preferred embodiment of the present invention, the massage hand tool is formed of wood. However, any material known to one of ordinary skill in the art may be employed to form the massage hand tool, such as plastic or metal, among other materials. Additionally, in a preferred embodiment of the present invention, the massage hand tool is coated with lacquer or polyurethane, however any coating known to one of ordinary skill in the art may be employed, even no coating at all. Also, several variations of engagement portions have been described, including spherical, convex and concave, however, any type of engagement portion or face to provide a massage known to one of ordinary skill in the art can be substituted.

1. A massage hand tool, comprising:
an engagement portion for engaging a person, the engagement portion having a first side and a second side; and
a first handle, mounted on the second side of the engagement portion.

2. The massage hand tool of claim 1, further comprising a second handle mounted on the second side of the engagement portion proximate to the first handle.

3. The massage hand tool of claim 2, wherein the second handle is mounted generally perpendicularly with reference to the first handle.

4. The massage hand tool of claim 1, wherein the massage hand tool is formed of wood.

5. The massage hand tool of claim 4, wherein the wood is finished with stain and coated with lacquer or polyurethane.

6. A massage hand tool, comprising:
a first substantially spherical engagement portion;
a first support shaft, having a first end and a second end, wherein the second end of the first support shaft is attached to the first substantially spherical engagement portion and the support shaft proceed substantially perpendicularly outward therefrom; and
a first handle, having a first end and a second end, wherein the second end of the first handle is mounted at the first end of the first shaft and proceeds substantially perpendicularly outward therefrom.

7. The massage hand tool of claim 6, further comprising:
a second substantially spherical engagement portion;
a second support shaft, having a first end and a second end, wherein the second end of the second support shaft is attached to the second substantially spherical engagement portion and the second support shaft proceeds substantially perpendicularly outward therefrom;
a second handle, having a first end and a second end, wherein the second end of the second handle is mounted at the first end of the second shaft and proceeds substantially perpendicularly outward therefrom; and
a transverse shaft, having a first end and a second end, wherein the second end is mounted on the first substantially spherical engagement portion and proceeding generally perpendicularly therefrom, and the first end of the transverse shaft is mounted on the second substantially spherical engagement portion and proceeding generally perpendicularly therefrom.

8. The massage hand tool of claim 7, wherein the transverse shaft is oriented generally perpendicularly in relation to the first support shaft and the second support shaft.

9. The massage hand tool of claim 6, wherein the massage hand tool is formed of wood.

10. The massage hand tool of claim 9, wherein the wood is finished with stain and coated with lacquer or polyurethane.

11. A massage hand tool, comprising:
an engagement portion, having a concave engagement face and a mounting end;
a support shaft, having a first end and a second end, the second end of the support shaft mounted at the mounting end of the engagement portion; and
a handle, mounted at the first end of the support shaft.

12. The massage hand tool of claim 11, wherein the handle and the engagement portion are generally mounted perpendicularly to one another.

13. The massage hand tool of claim 11, wherein the handle and the engagement portion are generally co-planar in orientation.

14. The massage hand tool of claim 13, wherein the length of the engagement portion is less than the length of the handle.

15. The massage hand tool of claim 13, wherein the length of the engagement portion is greater than the length of the handle.

16. The massage hand tool of claim 11, wherein the massage hand tool is formed of wood.

17. The massage hand tool of claim 16, wherein the wood is finished with stain and coated with lacquer or polyurethane.

18. A massage hand tool, comprising:
a first engagement portion, having a convex engagement face and a substantially flat mounting end;
a first support shaft, having a first end and a second end, the second end of the support shaft mounted at the substantially flat mounting end of the first engagement portion generally centrally; and
a first handle, mounted at the first end of the support shaft.

19. The massage hand tool of claim 18, wherein the first handle and the first engagement portion are generally mounted perpendicularly to one another.

20. The massage hand tool of claim 18, wherein the first handle and the first engagement portion are generally mounted co-planar in orientation to one another.

21. The massage hand tool of claim 20, further comprising:
a second engagement portion, having a convex engagement face and a substantially flat mounting end;
a second support shaft, having a first end and a second end, wherein the second end of the second support shaft is attached to the second engagement portion at the substantially flat mounting end of the second engagement portion generally centrally;
a second handle, having a first end and a second end, wherein the second end of the second handle is mounted at the first end of the second shaft and proceeds substantially perpendicularly outward therefrom; and
a transverse shaft, having a first end and a second end, wherein the second end is disposed between the first engagement portion and the second engagement portion, wherein the first end of the transverse shaft is mounted on the first engagement portion and proceeds generally perpendicularly therefrom, and the second end of the transverse shaft is mounted on the second engagement portion and proceeds generally perpendicularly therefrom.

22. The massage hand tool of claim 18, wherein the massage hand tool is formed of wood.

23. The massage hand tool of claim 22, wherein the wood is finished with stain and coated with lacquer or polyurethane.

24. A massage hand tool, comprising:
an engagement portion, adapted for mounting on a forearm, having a first end and a second end, wherein the first end of the engagement portion is generally adapted to be mounted proximate to the palm area, and the second end of the engagement portion is generally adapted to be mounted proximate to the elbow; and
a first strap, mounted on the engagement portion for securing the engagement portion to the periphery of the forearm.

25. The massage hand tool of claim 24, further comprising a second strap mounted on the engagement portion for securing the engagement portion to the periphery of the forearm.

26. A massage hand tool, comprising:
a first engagement portion;
a first support shaft, having a first end and a second end, wherein the second end of the first support shaft is attached to the first engagement portion and the support shaft proceed substantially perpendicularly outward therefrom; and
a first handle, having a first end and a second end, wherein the second end of the first handle is mounted at the first end of the first shaft and proceeds substantially perpendicularly outward therefrom.

27. The massage hand tool of claim 26, further comprising:
a second engagement portion;
a second support shaft, having a first end and a second end, wherein the second end of the second support shaft is attached to the second engagement portion and the second support shaft proceeds substantially perpendicularly outward therefrom;
a second handle, having a first end and a second end, wherein the second end of the second handle is mounted at the first end of the second shaft and proceeds substantially perpendicularly outward therefrom; and
a transverse shaft, having a first end and a second end, wherein the second end is mounted on the first engagement portion and proceeding generally perpendicularly therefrom, and the first end of the transverse shaft is mounted on the second engagement portion and proceeding generally perpendicularly therefrom.

28. The massage hand tool of claim 27, wherein the transverse shaft is oriented generally perpendicularly in relation to the first support shaft and the second support shaft.

29. The massage hand tool of claim 26, wherein the massage hand tool is formed of wood.

30. The massage hand tool of claim 29, wherein the wood is finished with stain and coated with lacquer or polyurethane.
